(19) United States
(12) Patent Application Publication
(10) Pub. No.: US 2009/0145462 A1
(43) Pub. Date: Jun. 11, 2009

(54) Maintaining an Ophthalmic Device in a Hydrated State

(76) Inventors: Kevin D. Beebe, Spencerport, NY (US); Matthew M. Place, Hilton, NY (US); Travis M. Fisher, Webster, NY (US); Thomas F. Natalie, Rochester, NY (US); Sandeep P. Pandit, Rochester, NY (US)

Correspondence Address: Bausch & Lomb Incorporated, One Bausch & Lomb Place, Rochester, NY, 14604-2701, US

(21) Appl. No.: 12/277,506

(22) Filed: Nov. 25, 2008

Related U.S. Application Data
(60) Provisional application No. 61/012,228, filed on Dec. 7, 2007.

(51) Int. Cl. B08B 3/10; B08B 13/00

(52) U.S. Cl. 134/18; 134/113

(57) ABSTRACT

An ophthalmic device hydration system includes an inspection station configured to receive a plurality of ophthalmic devices and fluid supply fluidly connected to the inspection station. The fluid supply contains a working fluid. The ophthalmic device hydration system also includes a hydration assembly disposed proximate the inspection station and configured to vaporize a volume of the working fluid.

### CROSS-REFERENCE TO RELATED APPLICATIONS

This application claims the benefit of Provisional Patent Application No. 61/012,228 filed Dec. 7, 2007 which is incorporated by reference herein.

### STATEMENT REGARDING FEDERALLY SPONSORED RESEARCH OR DEVELOPMENT

Not applicable.

### REFERENCE TO A “SEQUENCE LISTING”

Not applicable.

### BACKGROUND OF THE INVENTION

1. Field of the Invention

The present invention relates to equipment used to manufacture ophthalmic devices, and, in particular, to equipment used to manufacture contact lenses.

2. Description of Related Art

Soft hydrogel contact lenses have increased in popularity since they were first introduced in the 1970s. Such contact lenses are conventionally formed through a process in which the material used to make the lenses is placed between two halves of a casting mold, and the entire assembly is then cured to form the desired contact lens shape. After the curing process, the lens is removed from the casting mold and is immersed in a series of fluids to remove impurities therefrom. The lens is then taken to an inspection system or station where it is inspected for foreign particles, holes, and/or deformations caused by the manufacturing process.

While the lens is being transported from the upstream impurity removal equipment to components of the inspection system, however, the lens is often exposed to ambient air for extended periods of time. For example, the lens may be removed from working fluids of the impurity removal equipment and may be placed in a relatively dry holding cell while the lens is in que waiting to be presented to components of the inspection system. Exposing the lens to ambient air for extended periods can result in the formation of stresses within the lens and, ultimately, the lens can lose its circular shape as a result. Such deformities can be found by the inspection system and may result in rejection of the lens depending on their severity.

Existing inspection systems typically include a lens transportation device, a camera, a viewing monitor, and a computer. The computer is configured to run lens inspection/examination software which controls the camera during a lens inspection process. In examining the lens, the camera and, in particular, the software, can inspect the lens surfaces for the foreign particles, holes, and deformities discussed above, and the software can control the inspection system to reject a lens if such deformities are found thereon. Depending on the type of contact lens being examined and the throughput of the manufacturing line, rejections caused by deformation due to dehydration of the lenses can dramatically increase production costs and can severely hinder manufacturing efficiency.

Accordingly, the disclosed systems and methods are directed toward overcoming one or more of the problems set forth above.

### SUMMARY OF THE INVENTION

In an exemplary embodiment of the present disclosure, an ophthalmic device hydration system includes an inspection station configured to receive a plurality of ophthalmic devices and a fluid supply fluidly connected to the inspection station. The fluid supply contains a working fluid. The ophthalmic device hydration system also includes a hydration assembly disposed proximate the inspection station and configured to vaporize a volume of the working fluid.

In another exemplary embodiment of the present disclosure, a method of maintaining an ophthalmic device at a desired hydration level includes exposing the ophthalmic device to ambient air, vaporizing a first volume of working fluid, and directing the vaporized first volume of working fluid to the ophthalmic device. The method also includes substantially submerging the ophthalmic device in a second volume of working fluid. The method further includes sensing at least one characteristic of the ophthalmic device while the ophthalmic device is substantially submerged in the second volume of working fluid.

In still another exemplary embodiment of the present disclosure, a method of reducing deformation in a plurality of ophthalmic devices includes removing an ophthalmic device of the plurality of ophthalmic devices from a first volume of working fluid, ultrasonically vaporizing a second volume of working fluid, and exposing the ophthalmic device to the vaporized second volume of working fluid for a desired period of time. The method also includes substantially submerging the ophthalmic device in a third volume of working fluid after the desired period of time has expired and sensing at least one characteristic of the a surface of the ophthalmic device while the ophthalmic device is substantially submerged.

### BRIEF DESCRIPTION OF THE DRAWINGS

FIG. 1 is a partial diagrammatic illustration of an ophthalmic device forming system according to an exemplary embodiment of the present disclosure.

FIG. 2 is a partial diagrammatic illustration of a portion of the system shown in FIG. 1.

### DETAILED DESCRIPTION OF THE DRAWINGS

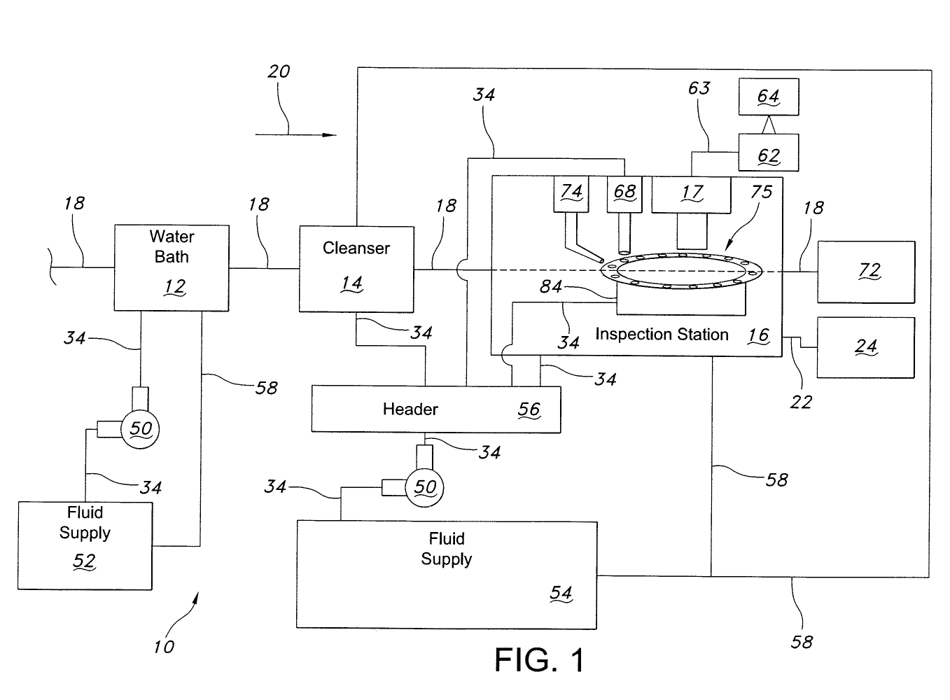

FIG. 1 illustrates an ophthalmic device forming system 10 according to an exemplary embodiment of the present disclosure. As shown in FIG. 1, the system 10 includes, for example, a water bath 12, a cleanser 14, an inspection station 16, and a packaging station 72. The water bath 12 can be connected to the cleanser 14 via a transport device 18 and the cleanser 14 can be connected to the inspection station 16 by the transport device 18. The packaging station 72 can also be connected to the inspection station 16 via the transport device 18. As shown in FIG. 1, the water bath 12 can be disposed upstream of the cleanser 14, the cleanser 14 can be disposed upstream of the inspection station 16, and the packaging station 72 can be disposed downstream of the inspection station 16. The inspection station 16 can include a hydration assembly 68 and a picker 74, and in an exemplary embodiment, the inspection station 16 can further include a vision system 75 comprising a sensor 17 and a carousel 84.

In forming an ophthalmic device such as, for example, a contact lens, casting molds can be dosed with a monomer, a polymer, and/or other lens forming materials. The entire casting mold assembly can then be placed into a curing apparatus where the ophthalmic device can be formed and/or otherwise cured. Once the lens is formed, a posterior portion of the casting mold can be removed and discarded, and the formed lens can be substantially adhered to the remaining or anterior portion of the casting mold. The lens and the anterior portion of the casting mold can then be placed in, for example, a solvent reduction oven where the lens and the anterior portion of the casting mold are immersed in a solvent to assist in separation. A plunger mechanism can then be used to apply a pressure to a portion of the anterior portion of the casting mold and a vacuum device can be used to remove the separate lens. The anterior portion of the casting mold can then be discarded and the formed lens can be transported to an edge forming apparatus wherein at least a portion of the substantially circular edges of the lens are rounded. The lens can then be coated with a plasma and/or other lens coating materials, and the coated lens can be transported to one or more machines configured to assist in removing impurities and inspecting the condition of the lens.

In an exemplary embodiment, a coated lens can first be transported to the water bath 12 via the transport device 18. The transport device 18 can be any apparatus and/or collection of machines or devices useful in transporting items having optical quality surfaces from one machine to another machine in an assembly and/or manufacturing environment. The transport device 18 can include one or more gripping devices such as, for example, fingers, hooks, graspers, and/or any other gripping devices known in the art. Such gripping devices (not shown) can be configured to delicately grasp a fragile item such as, for example, a partially formed ophthalmic device and safely transport the fragile item from machine to machine without causing damage thereto. In an exemplary embodiment, the transport device 18 can also include one or more vacuum devices (not shown). The vacuum devices can be configured to handle and/or otherwise grasp the ophthalmic devices while not causing any damage to the one or more optical quality surfaces of the ophthalmic devices during transport.

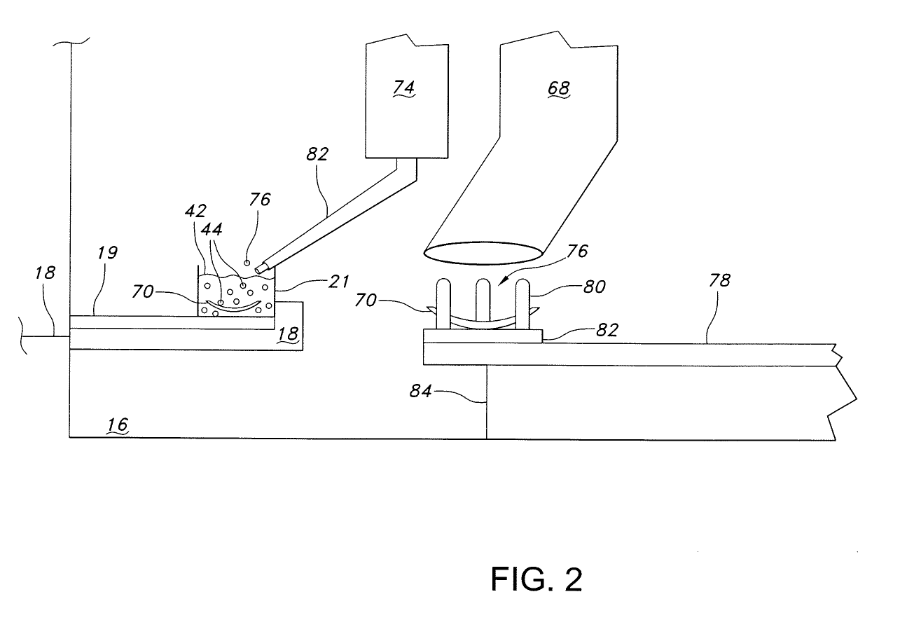

As shown in FIG. 2, in an additional exemplary embodiment of the present disclosure, the ophthalmic devices 70 formed and/or inspected by the system 10 can be housed in one or more carrying trays 19. The carrying trays 19 can be transported from, for example, the water bath 12 to the cleanser 14 and then to the inspection station 16 by the transport device 18. In such an exemplary embodiment, the transport device 18 can be configured to transport the carrying trays 19 between the components of the system 10 without causing any damage to, for example, the carrying trays 19 and/or the ophthalmic devices 70 carried thereby. The carrying trays 19 can comprise a plurality of substantially open cells 21, each configured to retain an ophthalmic device 70. In an exemplary embodiment, each carrying tray 19 may define sixteen or more cells 21, and it is understood that the substantially open cells 21 can include at least one open section 76 through which the ophthalmic device 70 can be relatively easily accessed. In an exemplary embodiment, the working fluid 42 disposed within the inspection station 16 and/or a probe 82 of the picker 74 may access the ophthalmic device 70 via the open section 76. The substantially open cells 21 can also enable the easy insertion and removal of an ophthalmic device 70 relative to the cell 21. Accordingly, the substantially open cells 21 may enable the probe 82 of the picker 74 to assist in removing the ophthalmic devices 70 from the carrying tray 19 and positioning the ophthalmic devices 70 in holders 82 of the carousel 84 prior to inspection.

Alternatively, as discussed above, the transport device 18 can also be configured to transport ophthalmic devices 70 individually between the components of the system 10. In such an alternative exemplary embodiment, the carrying trays 19 can be omitted.

Referring again to FIG. 1, the water bath 12 can be any device known in the art configured to assist in fluidly removing debris, contaminants, and/or other foreign materials from an ophthalmic device such as, for example, a contact lens. Such foreign materials may be adhered to and/or otherwise carried with the ophthalmic device in an ophthalmic device forming process, and the foreign materials can be, for example, dirt, dust, and/or pieces of polymer or monomer material left over from upstream ophthalmic device forming and/or curing processes. In an exemplary embodiment, the water bath 12 can be configured to remove isopropyl alcohol from the ophthalmic devices transported thereto. Isopropyl alcohol can be carried with the ophthalmic devices from components of the system 10 disposed upstream of the water bath 12. The water bath 12 can be configured to receive ophthalmic devices 70 and/or other devices or carrying trays 19 (FIG. 2) transported by the transport device 18.

The water bath 12 can include a housing and/or other components configured to receive and retain working fluid 42 such as, for example, de-ionized water, isopropyl alcohol, saline solution and/or other cleansing or hydrating agents. The housing of the water bath 12 can be made from any metal and/or alloy known in the art such as, for example, FDA approved 316 stainless steel. The water bath 12 can be fluidly connected to a fluid supply 52 configured to store the working fluid 42 discussed above and/or direct a pressurized flow of the working fluid 42 to the water bath 12. The water bath 12 can also include one or more pressurization devices (not shown) configured to direct the working fluid 42 supplied from the fluid supply 52 towards the ophthalmic devices 70 delivered by the transportation device 18. In an exemplary embodiment, the pressurization devices can include one or more nozzles or other like structures.

The fluid supply 52 can be any drum, container, sump, or other fluid storage device known in the art configured to house and/or otherwise store a large volume of working fluid 42. In an exemplary embodiment, fluid supply 52 can be a fluid supply of the manufacturing facility in which the system 10 is operating. In such an exemplary embodiment, the fluid supply 52 can be a water tower or other like fluid storage device. As shown in FIG. 1, the fluid supply 52 can be fluidly connected to the water bath 12 via one or more supply lines 34. The supply lines 34 can be any tube, pipe, hose, and/or other structure known in the art configured to transmit a pressurized flow of fluid between two components in a production environment. The supply lines 34 can be made from any metal, alloy, plastic, and/or other material useful for transmitting pressurized flows of fluid, and such materials may include, PVC, copper, and FDA approved 316 stainless steel. In an exemplary embodiment, the supply lines 34 can be substantially rigid pipes. Alternatively, the supply lines 34 can be a combination of substantially rigid piping and substantially flexible hoses. The water bath 12 can also be fluidly connected to the supply 52 via a return line 58 configured to direct a flow of working fluid 42 from the water bath 12 to the fluid supply 52. The return line 58 can be mechanically similar to the supply lines 34 described above. In addition, it is understood that the fluid supply lines 34 and the return line 58 can include a number of valves and/or joints to assist in fluidly connecting the water bath 12 to the fluid supply 52.

A pump 50 can be fluidly connected between the fluid supply 52 and the water bath 12. The pump 50 can be configured to draw working fluid 42 from the fluid supply 12 and to supply a pressurized flow of the working fluid 42 to the water bath 12 via the supply lines 34. The pump 50 can be any fluid pressurization device known in the art such as, for example, a positive displacement pump or a rotodynamic pump. The pump 50 can also include a power source such as, for example, an electric motor configured to supply rotary power to, for example, an input shaft of the pump 50.

Referring again to FIG. 1, the cleanser 14 can be disposed adjacent to the water bath 12 and can be configured to receive ophthalmic devices 70 and/or other devices or carrying trays 19 transported by the transport device 18. The cleanser 14 can include a housing and/or other components configured to contain fluids such as, for example, water. The cleanser 14 can be similar in construction to the water bath 12 and can be configured to cleanse and/or otherwise remove impurities from the ophthalmic devices 70 transported thereto. In an exemplary embodiment, the cleanser 14 can also include a cleansing agent supply and one or more pressurization devices (not shown). In an exemplary embodiment, the pressurization devices can include one or more nozzles or other like structures. The pressurization devices can be configured to inject and/or otherwise combine a mild soap-like cleaning agent or other cleaning agent with the working fluid 42 supplied from the fluid supply 52. A working fluid 42/cleaning agent mixture can, thus, be directed towards the ophthalmic devices 70 within a portion of the cleanser 14 to remove impurities from the devices 70.

As discussed above with respect to the water bath 12, the cleanser 14 can be fluidly connected to a fluid supply 54. The fluid supply 54 can be, for example, a tank, container and/or any other device configured to store and/or retain a supply of fluid such as, for example, water or other working fluids 42.

As shown in FIG. 1, a pump 50 can be configured to draw working fluid 42 from the fluid supply 54 and to supply a pressurized flow of working fluid 42 to the cleanser 14. In an exemplary embodiment, the pump 50 can be configured to direct a pressurized flow of working fluid 42 to a header 56. The header 56 can be, for example, a manifold or other device useful in delivering a pressurized flow of fluid to a plurality of components. The cleanser 14, header 56, and/or fluid supply 54 can be made from any of the materials discussed above with respect to the supply line 34 and return line 58. In an exemplary embodiment, the cleanser 14, header 56, and/or fluid supply 54 can be made from FDA approved 316 stainless steel or other like metals or alloys. The pump 50 connecting the fluid supply 54 to the header 56 can be substantially similar to the pump 50 connecting the fluid supply 52 to the water bath 12. In an additional exemplary embodiment, the pump 50 fluidly connected to the fluid supply 54 can have a greater pumping capacity than the pump 50 fluidly connected to the fluid supply 52. As shown in FIG. 1, working fluid 42 from the fluid supply 54 can be directed to the cleanser 14 via supply lines 34 and working fluid 42 exiting in the cleanser 14 can be returned to the fluid supply 54 via the return line 58.

The inspection station 16 can be disposed adjacent to the cleanser 14, and cleaned ophthalmic devices 70, carrying trays 19, and/or other ophthalmic device handling components can be transported from the cleanser 14 to the inspection station 16 by the transport device 18. The inspection station 16 can be any conventional inspection station or apparatus known in the art. The inspection station 16 can include, for example, a housing similar to the housings described above with respect to the water bath 12 and the cleanser 14. The inspection station 16 can be configured to receive a pressurized flow of working fluid 42 from the fluid supply 54. As shown in FIG. 1, a supply line 34 can be configured to direct a pressurized flow of the working fluid 42 from the header 56 to the inspection station 16 directly and/or to individual components of the inspection station 16 such as, for example, the hydration assembly 68 and the carousel 84. The pressurized flow of working fluid 42 can be, for example, delivered to components of the inspection station 16 configured to rinse, cleanse, and/or otherwise hydrate the ophthalmic devices 70 prior to and/or during the inspection process. It is understood that, in an exemplary embodiment, the inspection station 16, the hydration assembly 68, the carousel 84, and/or the cleanser 14 can be connected to dedicated pumps 50. In such an exemplary embodiment, the header 56 can be removed, and the inspection station 16, the hydration assembly 68, the carousel 84, and/or the cleanser 14, and their corresponding pumps 50, can be connected directly to the fluid supply 54.

As shown in FIGS. 1 and 2, the hydration assembly 68 can be disposed proximate and/or at least partially connected to the inspection station 16. The hydration assembly 68 can be configured to assist in maintaining ophthalmic devices 70 delivered by the transport device 18 at a desired hydration level and/or state. Maintaining the ophthalmic devices 70 at the desired hydration level can result in the ophthalmic devices 70 maintaining a substantially circular/disc-shaped configuration. The hydration assembly 68 can comprise any hydration components known in the art such as, for example, an ultrasonic vaporizer, a water atomization/misting system, a low velocity water shower, a steam vaporizer and/or other like components. Such systems and/or components can be configured to assist in maintaining an ophthalmic device hydration level in environments in which the ophthalmic devices 70 are exposed to, for example, ambient air or other dehydrating gases. Such environments can exist in multiple locations in the system 10, such as, for example, the region downstream of the cleanser 14 and upstream of the sensor 17. A portion of this region can be defined by, for example, the inspection station 16.

In an exemplary embodiment, the ophthalmic devices 70 can be exposed to air while awaiting presentation to, for example, the vision system 75 of the inspection station 16. While the vision system 75 may include components configured to hydrate the ophthalmic devices 70 during inspection, the hydration assembly 68 may be configured to maintain the ophthalmic devices at a desired hydration level during transition from, for example, the cleanser 14 to the vision system 75. As shown in FIG. 1, the hydration assembly 68 can be fluidly connected to, for example, the header 56 and the fluid supply 54 by a supply line 34. Thus, the hydration assembly 68 can be configured to substantially saturate the environment of the ophthalmic devices 70 with, for example, working fluids 42 such as de-ionized water and/or other like aqueous liquids. The hydration assembly 68 can also be configured to maintain the desired hydration level without increasing the temperature of the ophthalmic devices 70 or of the components of the system 10 proximate the hydration assembly 68. As a result, dehydration rates of the ophthalmic devices 70 caused by elevated ambient and/or system component temperatures can be reduced by employing hydration assemblies 68 of the type described herein.

As shown in FIG. 1, the carousel 84 of the vision system 75 can be mounted within and/or otherwise connected to the inspection station 16 proximate the hydration assembly 68. The carousel 84 can be any known assembly and/or collection of components configured to receive a plurality of ophthalmic devices 70 and maintain the ophthalmic devices 70 in a hydrated state during inspection by one or more sensors 17. In an exemplary embodiment, the vision system 75 can be a wet vision system, and the carousel 84 can be a component of the wet vision system 75 configured to submerge and/or otherwise hydrate a plurality of ophthalmic devices 70 within a working fluid 42 during inspection by the sensor 17.

The carousel 84 can be of any shape, size and/or other configuration known in the art and can have a number of moving components configured to assist in positioning the ophthalmic devices 70 requiring inspection proximate one or more components of the inspection station 16 such as, for example, the sensor 17. In an exemplary embodiment, the carousel 84 can include a substantially circular wheel 78 (FIG. 2) configured to assist in supporting individual ophthalmic devices 70 during the inspection process. The wheel 78 can be, for example, rotatably mounted to the carousel 84 such that the ophthalmic devices 70 disposed thereon can be rotated and/or otherwise positioned proximate the sensor 17 during inspection.

As shown in FIG. 1, the carousel 84 can be fluidly connected to, for example, the header 56 and the fluid supply 54 by supply line 34. Thus, the carousel 84 and its components can be configured to substantially submerge the ophthalmic devices 70 disposed thereon during inspection by the sensor 17. It is understood that the fluids used to submerge the ophthalmic devices can be, for example, working fluids 42 such as de-ionized water and/or other like aqueous liquids stored within the fluid supply 54.

As shown in FIG. 2, a holder 82 can be mounted upon and/or otherwise connected to the wheel 78. The holder 82 can be sized, shaped, and/or otherwise configured to support and/or immobilize an ophthalmic device 70 during the inspection process. The holder 82 can be of any configuration known in the art and can be configured to immobilize an ophthalmic device 70 without causing damage to the optical surfaces of the ophthalmic device 70 disposed thereon. The holder 82 can include a plurality of legs 80 to assist in immobilizing the ophthalmic device 70. The legs 80 can be any shape, size, length, and/or other configuration known in the art, and can be configured to assist in immobilizing the ophthalmic device 70 while the wheel 78 is, for example, rotated. Legs 80 can also be configured to assist in immobilizing the ophthalmic device 70 while the ophthalmic device 70 is subjected to a flow of working fluid 42 and/or while the ophthalmic device 70 is substantially submerged within a volume of the working fluid 42 during an inspection process. While FIG. 2 illustrates the holder 82 having three legs 80, it is understood that the holder 82 can have any number of legs useful in substantially immobilizing an ophthalmic device 70.

In addition, although FIG. 2 illustrates the legs 80 as having a substantially uniform shape along substantially their entire length, it is understood that the legs 80 can have any shape, size, and/or other configuration useful in substantially immobilizing the ophthalmic device 70 when disposed within the holder 82. For example, one or more of the legs 80 can have an angled portion proximate a top portion of the leg 80 and configured to assist in retaining the ophthalmic device 70 once disposed within the holder 82. As shown in FIG. 2, the holder 82 can define one or more open sections 76 proximate the legs 80. In an exemplary embodiment, the angled portion of the leg 80 can be mechanized and/or otherwise moveable. In such an embodiment, the angled portion of at least one of the legs 80 and/or a plurality of the legs 80 themselves can be moveable so as to form an augmented open section 76 while an ophthalmic device 70 is being disposed within and/or removed from the holder 82. In addition, one or more of the legs 80 can be tapered, mounted at a desirable angle relative to the wheel 78, rounded, bevelled, and/or otherwise configured to assist in retaining and/or substantially immobilizing the ophthalmic device 70 as described above. As described above, with respect to the cell 21 of the carrying tray 19, the open section 76 can be configured to allow for easy access to the ophthalmic devices 70 disposed within the holder 82 and can also assist in disposing the ophthalmic devices 70 within and/or removing the ophthalmic devices 70 from the holder 82.

As shown in FIG. 2, the picker 74 can be disposed proximate, for example, the carousel 84 and the hydration assembly 68. The picker 74 can be any apparatus and/or collection of machines or devices useful in safely transporting items having optical quality surfaces from one location within a machine to another location within the same machine in an assembly and/or manufacturing environment. The picker 74 can include, for example, a probe 82 configured to assist in safely transporting and/or otherwise handling an ophthalmic device 70. The probe 82 of the picker 74 can include, for example, one or more gripping devices. Such gripping devices can include, for example, fingers, hooks, graspers, suction devices, and/or any other manipulation devices known in the art. The probe 82 can be configured to delicately grasp and/or handle a fragile item such as, for example, an ophthalmic device 70 and safely transport the ophthalmic device 70 from a first position within a component of the system 10 to a second position within the component of the system 10 without causing damage to the ophthalmic device 70. For example, the picker 74 can be configured such that the probe 82 can remove an ophthalmic device 70 from a cell 21 of the carrying tray 19 and place the removed ophthalmic device 70 within the holder 82 without causing damage to the optical surfaces of the ophthalmic device 70.

In an exemplary embodiment, the picker 74 can include one or more vacuum devices (not shown). The vacuum devices can be fluidly connected to the probe 82 and can be configured to assist in handling and/or otherwise grasping the ophthalmic devices 70 while not causing any damage to the optical surfaces of the ophthalmic devices 70 during transport. It is understood that components of the picker 74 and/or the picker 74 itself can be movable relative to the inspection station 16 and/or the carousel 84. In an exemplary embodiment, the picker 74 can be mounted to a mechanized component of the inspection station 16 such as, for example, a robot arm, a belt, a tray, and/or any other component configured to facilitate movement of the picker 74 within the inspection station 16. Such components can be driven by, for example, one or more electric motors (not shown) or other like components configured to provide motion to mechanical and/or electromechanical devices.

Components of the picker 74, the hydration assembly 68, and/or the carousel 84 can be electrically connected to, for example, a controller 62 (described in further detail below) configured to assist in controlling, for example, the position, movement, activation, and/or deactivation thereof. Such connections can be facilitated by one or more connection lines 63 (not shown) described in greater detail below with respect to the sensor 17.

The sensor 17 can be any diagnostic device such as, for example, a thermocouple, a camera, and/or a pressure sensor, configured to sense one or more characteristics of an ophthalmic device 70. In an exemplary embodiment, the sensor 17 can be a high resolution camera and/or other video, photographic, or image sensing device configured to sense, measure, and/or otherwise analyze a surface of an ophthalmic device delivered in proximity thereto. The inspection station 16 can be configured to direct and/or otherwise immerse ophthalmic devices 70 delivered thereto via the transport device 18 in a volume of working fluid 42 supplied by the fluid supply 54. Accordingly, the sensor 17 can be configured to obtain images of the ophthalmic devices 70 in a substantially aqueous environment. It is understood that the transport device 18 can enable the ophthalmic devices 70 transported thereby to be movable relative to the inspection station 16.

Similar to the picker 74 and the hydration assembly 68, the sensor 17 can be configured and/or otherwise mounted within the inspection station 16 to be controllably and/or otherwise programmably movable relative to the transport device 18 and/or the ophthalmic devices 70 transported thereby. The sensor 17 can be mounted to tracks, motors, belts, robot arms, and/or other devices (not shown) configured to enable relative movement between the sensor 17 and ophthalmic devices 70 delivered to the inspection station 16.

The sensor 17 can be electrically connected to the controller 62 of the system 10. The controller 62 can include, for example, an ECU, a computer, and/or any other electrical control device known in the art. The controller 78 can include one or more operator interfaces 64 such as, for example, a monitor, a keyboard, a mouse, a touch screen, and/or any other devices useful in entering, reading, storing, and/or extracting data from the devices to which the controller 62 is connected. The controller 62 can be configured to exercise one or more control algorithms and/or control the devices to which it is connected based on one or more preset programs. For example, the controller 62 can be configured to control the sensor 17 to obtain images of ophthalmic devices 70 delivered to the inspection station 16 via the transport device 18. The controller 62 can also be configured to operate and/or otherwise execute image software loaded thereon and configured to inspect the images obtained by the sensor for defects in the ophthalmic devices 70. The controller 62 can also be configured to store and/or collect images and/or other data regarding the ophthalmic devices 70 that are observed. Such data can assist a user in determining the quality and/or usability of the observed ophthalmic device.

The controller 62 can be connected to, for example, the sensor 17, the hydration assembly 68, the picker 74, the carousel 84 and/or other components of the vision system 75 via one or more connection lines 63. The pumps 50, the motors (not shown) connected to pumps 50, and/or other devices of the system 10 can also be electrically connected to the controller 62 via connection lines 63 (not shown). The connection lines 63 can consist of any conventional electrical connection means known in the art such as, for example, wires or other like connection structures, as well as wireless communication means. Through these electrical connections, the controller 62 can be configured to receive, for example, sensed image data from the sensor 17. In particular, the controller 62 can be configured to receive images of the optical quality surfaces of the ophthalmic devices 70 delivered to the inspection station 16 by the transport device 18. Based on the sensed images, the controller 62 can be configured to control the system 10 to accept the inspected ophthalmic for commercial sale or reject the ophthalmic devices 70 based on one or more detected impurities, lens deformations, and/or other ophthalmic device characteristics.

The transport device 18 can be configured to direct accepted ophthalmic devices 70 from the inspection station 16 to the packaging station 72 of the system 10. The packaging station 72 can be disposed downstream of the inspection station 16 and can be configured to package the accepted ophthalmic devices 70 into, for example, a blister package useful for commercial sale. The inspection station 16 can also be configured to direct the rejected ophthalmic devices 70 to a bin 24 via a transport device 22. The transport device 22 can be substantially similar in configuration to the transport device 18 and the bin 24 can be, for example, a reject bin of the system 10. Ophthalmic devices 70 directed to the bin 24 can be melted down and/or otherwise recycled for use in future ophthalmic device forming processes. Alternatively, the ophthalmic devices 70 directed to bin 24 can be discarded.

### INDUSTRIAL APPLICABILITY

The ophthalmic device forming system 10 of the present disclosure can be used with a series of other machines for the inspection and/or formation of ophthalmic devices 70 such as, for example, contact lenses. The system 10 can be configured for use with and/or otherwise included in, for example, an assembly line used to manufacture contact lenses and, in an exemplary embodiment, the system 10 can be used to inspect one or more ophthalmic devices 70 prior to packaging the devices 70 in a blister pack or other commercial sale container.

In particular, a hydration assembly 68 of the present disclosure can be utilized to efficiently and reliably maintain ophthalmic devices 70 at a desired hydration level when the ophthalmic devices 70 are exposed to ambient air such as, for example, when the ophthalmic devices 70 are awaiting presentation to components of the vision system 75. As discussed above, when ophthalmic devices 70, such as, for example, contact lenses are exposed to ambient air for extended periods of time, the lenses can begin to dehydrate. In an exemplary embodiment, such dehydration can begin after approximately 2-4 minutes of exposure to ambient air. As the lens begins to dehydrate, internal stresses can develop in the lenses. These stresses can result in non-uniform shrinkage and/or other lens deformation. Depending on the magnitude, such deformation can cause the vision system 75 to reject the lens.

However, utilizing a hydration assembly 68 such as, for example, the ultrasonic vaporizer and/or other systems/assemblies described above, can enable the system 10 to maintain a desired lens hydration level while the lenses are, for example, awaiting inspection or laying idle as a result of machine downtime. In an exemplary embodiment, the desired lens hydration level can be at least, approximately 90% humidity. In an additional exemplary embodiment, the desired lens hydration level can be at least, approximately, 95% humidity. The hydration assembly 68 of the present disclosure also enables the system 10 to maintain the desired lens hydration level without increasing the temperature of the lenses or of the components of the system 10 proximate the hydration assembly 68. Accordingly, the configuration of the hydration assembly 68 discussed herein assists in reducing dehydration rates of the lenses that could result due to the addition of heat.

Moreover, the hydration assemblies 68 described herein are configured to minimize and/or otherwise substantially eliminate the introduction of gas bubbles to the lenses downstream of the cleanser 14. It is understood that, due to the turbulent flow of the working fluid 42, gases such as, for example, air can become entrained within the working fluid 42 delivered to, for example, the water bath 12, the cleanser 14, and/or the inspection station 16. Once entrained within the working fluid 42 these gases form the bubbles 44 illustrated in FIG. 2. Once the ophthalmic devices 70 are immersed within the working fluid 42, the bubbles 44 carried thereby can adhere to one or more surfaces of the ophthalmic devices 70 and can remain adhered to the ophthalmic devices 70 as the ophthalmic devices 70 are transported to the inspection station 16. Detection of the adhered bubbles 44 by the sensor 17 can result in the indication of a false negative on an otherwise acceptable ophthalmic device 70. Substantially eliminating the bubbles 44 and/or minimizing the introduction of bubbles 44 at the inspection station 16, however, can substantially reduce the number of false negatives indicated by the system 10 and can thereby increase the efficiency and overall throughput thereof.

In an exemplary ophthalmic device inspection and/or forming process of the present disclosure, the transport device 18 can deliver one or more ophthalmic devices 70 to the water bath 12. For example, the transport device 18 can deliver a carrying tray 19 having sixteen cells 21, each cell 21 having an ophthalmic device 70 disposed therein. Upon receiving the ophthalmic devices 70, the pump 50 can be activated to supply a pressurized flow of working fluid 42 from the fluid supply 52, through supply line 34, to the water bath 12. The working fluid 42 can be, for example, de-ionized water or another lens cleaning agent. The water bath 12 can substantially immerse and/or otherwise wash the ophthalmic devices 70 therein with the pressurized flow of working fluid 42 such that substantially all impurities and/or other foreign objects are removed from the optical quality surfaces of the ophthalmic devices 70. In addition, the water bath 12 can assist in removing isopropyl alcohol carried by the ophthalmic devices 70. It is understood that, in an exemplary embodiment, isopropyl alcohol may be deposited on the ophthalmic devices 70 by system components disposed upstream of the water bath 12. A portion of the working fluid 42 supplied to the water bath 12 can return to the fluid supply 52 via the return line 58.

As illustrated by arrow 20 in FIG. 1, the ophthalmic devices 70 can then be transferred from the water bath 12 to the cleanser 14 via the transport device 18. It is understood that, as a result of the processes performed by the water bath 12, working fluid 42 utilized in the water bath 12 can be resident on one or more surfaces of the ophthalmic devices 70 transferred to the cleanser 14. Accordingly, the cleanser 14 can assist in substantially removing the working fluid 42, supplied by the water bath 12, from the ophthalmic devices 70. In an exemplary embodiment, the ophthalmic devices 70 can be immersed within a new supply of working fluid 42 directed to the cleanser 14 from the fluid supply 54. As discussed above, the working fluid 42 disposed within the fluid supply 54 can be de-ionized water, saline solution, and/or any other working fluid 42 that is acceptable and/or non-irritant to the human eye. The pump 50 can direct a pressurized flow of working fluid 42 to the cleanser 14 from the fluid supply 54 and, in an exemplary embodiment, the pump 50 can supply a pressurized flow of the working fluid 42 to the header 56 and the supply lines 34 can direct the pressurized flow to the cleanser 14. In addition, components of the cleanser 14 can direct a mild soap-like agent and/or other like lens cleaning agents to the ophthalmic devices. In an exemplary embodiment, the lens cleaning agents can be mixed with the pressurized flow of working fluid 42 delivered to the cleanser 14. Once the pressurized flow of working fluid 42 has been supplied to the cleanser 14, a portion of the working fluid 42 can be returned to the fluid supply 54 via the return line 58. After the ophthalmic devices 70 have been acted upon by the cleanser 14, the ophthalmic devices 70 can be transferred to the inspection station 16 by the transport device 18.

Once the transport device 18 reaches the inspection station 16, the picker 74 can be actuated to remove an ophthalmic device 70 from the cell 21 in which it is disposed. In particular, the probe 82 can be controlled and/or otherwise manipulated to grasp, through vacuum and/or substantially mechanical means, the ophthalmic device 70, remove the device 70 from the cell 21 via the open section 76, and place the removed ophthalmic device 70 within an empty holder 82 of the carousel 84. The probe 82 may dispose the ophthalmic device 70 between the legs 80 of the holder 82 via the open section 76 defined thereby. It is understood that one or more of the legs 80 can be controlled and/or otherwise manipulated to augment the open section 76 while the ophthalmic device 70 is being disposed within the holder 82 and after the ophthalmic device 70 has been so disposed, the augmented open section 76 can be returned to a substantially closed/original position to assist in substantially immobilizing the ophthalmic device 70.

Once the ophthalmic device 70 has been disposed within the holder 82, the hydration assembly 68 can be activated to maintain the ophthalmic device 70 at a desired hydration level prior to inspection by the vision system 75. Each of the hydration assemblies 68 discussed above can be configured to vaporize a volume of working fluid 42 directed thereto. For example, a hydration assembly 68 comprising an ultrasonic vaporizer can excite water molecules to form a column of relatively small water droplets having a size of, approximately 0.5 μm3/droplet at an ambient temperature of the system 10. In such an exemplary embodiment, the ultrasonic vaporizer can be configured to ultrasonically vaporize working fluid 42 directed thereto. It is understood that, in an additional exemplary embodiment, a hydration assembly 68 comprising a steam vaporizer can add thermal energy to the environment immediately surrounding the ophthalmic device 70 and can promote a relatively large amount of condensation on relatively cooler surfaces of, for example, the inspection station 16. In still further exemplary embodiments, a hydration assembly 68 comprising a mister can generate larger water droplets than the ultrasonic vaporizer. Such droplets can range in size from approximately 523 μm3/droplet to approximately 65,450 μm3/droplet. These larger droplets can simulate a substantially steady stream of working fluid 42 being sent to the ophthalmic device 70. Due to the activation of the hydration assembly 68, removing the ophthalmic device 70 from the working fluid 42 carried by, for example, the cell 21 and disposing the ophthalmic device 70 within the holder 82 results in the addition of substantially no internal stresses to the ophthalmic device 70 and, thus, results minimizes and/or substantially eliminates any resulting deformation or non-uniform shrinkage thereof.

Once the vision system 75 is ready to accept the hydrated ophthalmic device 70 for inspection by, for example, the sensor 17, the wheel 78 can rotate the ophthalmic device 70 into position proximate the sensor 17. At this time, the ophthalmic device 70 can again be substantially submerged in a volume of working fluid 42 within the inspection station 16 so as not to dehydrate the ophthalmic device 70 during inspection. As discussed above with respect to the water bath 12 and the cleanser 14, the flow of working fluid 42 directed to the inspection station 16 can be pressurized.

The sensor 17 and/or other components of the vision system 75 can sense and/or otherwise detect a characteristic of the ophthalmic device 70. As discussed above, such a characteristic can include, for example, surface quality, diameter, and/or other detectable characteristics. Such a characteristic could also include, for example, any trademarks, symbols, logos, characters, or other product/source identifiers. The sensor 17 can obtain one or more images of the ophthalmic device 70 being examined and can transmit the obtained images to the controller 62 whereby the controller 62 may, through the use of preloaded examination software, determine the status, health, and/or quality of the ophthalmic device being examined. In particular, the software executed by the controller 62 can determine whether or not the examined ophthalmic device 70 contains any defects. Based on this defect determination, the controller 62 can determine whether to allow the ophthalmic device 70 to be passed on from the inspection station 16 to the packaging station 72 for insertion and/or packaging within a blister pack or other commercial sale container. Alternatively, if the detected characteristic is not satisfactory, the controller 62 can make the determination to reject the examined ophthalmic device 70 and pass the rejected device 70 to the bin 24 via the transport device 22.

Other embodiments of the disclosed system 10 will be apparent to those skilled in the art from consideration of this specification. It is intended that the specification and examples be considered as exemplary only, with the true scope of the invention being indicated by the following claims.

What is claimed is:

1. An ophthalmic device hydration system, comprising:
an inspection station configured to receive a plurality of ophthalmic devices;
a fluid supply fluidly connected to the inspection station, the fluid supply containing a working fluid; and
a hydration assembly disposed proximate the inspection station and configured to vaporize a volume of the working fluid.

2. The system of claim 1, wherein the hydration assembly comprises an ultrasonic vaporizer.

3. The system of claim 1, wherein a component of the hydration assembly is programmably moveable relative to each device of the plurality of ophthalmic devices to assist in maintaining the ophthalmic devices at a desired hydration level.

4. The system of claim 3, wherein the desired hydration level is at least 95% humidity.

5. The system of claim 1, further including a carousel configured to temporarily submerge the plurality of ophthalmic devices in the working fluid contained within the inspection station.

6. The system of claim 5, further including at least one sensor configured to detect a characteristic of each device of the plurality of ophthalmic devices while the plurality of ophthalmic devices are temporarily submerged.

7. The system of claim 5, the carousel comprising a plurality of holders, each holder configured to substantially immobilize an ophthalmic device of the plurality of ophthalmic devices while the ophthalmic device is disposed within the holder.

8. The system of claim 7, wherein each holder comprises a plurality of legs configured to assist in substantially immobilizing the ophthalmic device.

9. The system of claim 8, wherein at least one leg of the plurality of legs is moveable.

10. The system of claim 5, further including a picker configured to transport an ophthalmic device of the plurality of ophthalmic devices to a holder of the carousel.

11. The system of claim 1, wherein the hydration assembly is configured to direct the vaporized volume of working fluid to at least one ophthalmic device of the plurality of ophthalmic devices while the at least one ophthalmic device is exposed to ambient air.

12. The system of claim 1, wherein the hydration assembly is configured to direct the vaporized volume of working fluid to at least one ophthalmic device of the plurality of ophthalmic devices prior to inspection of the at least one ophthalmic device by a sensor of the inspection station.

13. A method of maintaining an ophthalmic device at a desired hydration level, comprising:
exposing the ophthalmic device to ambient air;
vaporizing a first volume of working fluid and directing the vaporized first volume of working fluid to the ophthalmic device;
substantially submerging the ophthalmic device in a second volume of working fluid; and
sensing at least one characteristic of the ophthalmic device while the ophthalmic device is substantially submerged in the second volume of working fluid.

14. The method of claim 13, wherein vaporizing the first volume of working fluid comprises ultrasonically vaporizing the first volume of working fluid.

15. The method of claim 13, wherein exposing the ophthalmic device to ambient air comprises removing the ophthalmic device from a third volume of working fluid.

16. The method of claim 15, further including disposing the removed ophthalmic device within a holder proximate a hydration assembly.

17. The method of claim 13, further including programmably positioning a portion of a hydration assembly relative to the ophthalmic device.

18. The method of claim 13, further including directing the ophthalmic device to a packaging station based on the sensed at least one characteristic.

19. A method of reducing deformation in a plurality of ophthalmic devices, comprising:
removing an ophthalmic device of the plurality of ophthalmic devices from a first volume of working fluid;
ultrasonically vaporizing a second volume of working fluid;
exposing the ophthalmic device to the vaporized second volume of working fluid for a desired period of time; and
substantially submerging the ophthalmic device in a third volume of working fluid after the desired period of time has expired and sensing at least one characteristic of the a surface of the ophthalmic device while the ophthalmic device is substantially submerged.

20. The method of claim 19, wherein removing the ophthalmic device from the first volume of working fluid results in the addition of substantially no internal stresses to the ophthalmic devices.
